(19) United States
(12) Patent Application Publication
(10) Pub. No.: US 2025/0085463 A1
(43) Pub. Date: Mar. 13, 2025

(54) Color Coatings with Two-Layer Thin-Film Interference Filter

(71) Applicant: Apple Inc., Cupertino, CA (US)

(72) Inventors: Brian S Tryon, Redwood City, CA (US); Jozef M Matlak, San Francisco, CA (US); Ziqing Duan, San Jose, CA (US); Yi Zhou, Taicang (CN); Di Fan, Shenzhen (CN); Donghai Yu, Guangzhou (CN)

(21) Appl. No.: 18/523,605

(22) Filed: Nov. 29, 2023

Related U.S. Application Data
(60) Provisional application No. 63/581,250, filed on Sep. 7, 2023.

(51) Int. Cl. G02B 5/28

(52) U.S. Cl. CPC G02B 5/286

(57) ABSTRACT

An electronic device may be provided with conductive structures such as conductive housing structures. A visible-light-reflecting coating may be formed on the conductive structures. The coating may have adhesion and transition layers, an opaque coloring layer on the adhesion and transition layers, and a two-layer thin-film interference filter on the opaque coloring layer. The two-layer thin-film interference filter may an uppermost diamond-like carbon (DLC) or CrSiCN layer and a lowermost SiCrCN layer. The coating may exhibit a dark blue or black color that has a relatively uniform visual response even when the underlying conductive structures have a three-dimensional shape.

This application claims the benefit of U.S. Provisional Patent Application No. 63/581,250, filed Sep. 7, 2023, which is hereby incorporated by reference herein in its entirety.

### FIELD

This disclosure relates generally to coatings for electronic device structures and, more particularly, to visible-light-reflecting coatings for conductive electronic device structures.

### BACKGROUND

Electronic devices such as cellular telephones, computers, watches, and other devices contain conductive structures such as conductive housing structures. The conductive structures are provided with a coating that reflects particular wavelengths of light so that the conductive components exhibit a desired visible color.

It can be challenging to provide coatings such as these with a desired color brightness. In addition, if care is not taken, the coatings may exhibit unsatisfactory optical performance across different operating environments and conductive structure geometries.

### SUMMARY

An electronic device may include conductive structures such as conductive housing structures. A visible-light-reflecting coating may be formed on the conductive structures. The coating may have adhesion and transition layers, an opaque coloring layer on the adhesion and transition layers, and a two-layer thin-film interference filter on the opaque coloring layer. The two-layer thin-film interference filter may an uppermost diamond-like carbon (DLC) or CrSiCN layer and a lowermost SiCrCN layer. The coating may exhibit a dark blue or black color that has a relatively uniform visual response even when the underlying conductive structures have a three-dimensional shape.

An aspect of the disclosure provides an apparatus. The apparatus can include a conductive substrate. The apparatus can include a coating on the conductive substrate and having a color. The coating can include adhesion and transition layers. The coating can include a two-layer thin-film interference filter on the adhesion and transition layers, wherein the two-layer thin-film interference filter comprises a CrSiCN layer.

An aspect of the disclosure provides an electronic device. The electronic device can include a conductive structure. The electronic device can include a coating on the conductive structure and having a color. The coating can include adhesion and transition layers. The coating can include a thin-film interference filter on the adhesion and transition layers, wherein the thin-film interference filter has an uppermost layer that includes CrSiCN and has a lowermost layer that includes CrSiCN.

An aspect of the disclosure provides an electronic device. The electronic device can include a conductive structure. The electronic device can include a coating on the conductive structure and having a color. The coating can include adhesion and transition layers. The coating can include a thin-film interference filter on the adhesion and transition layers, wherein the thin-film interference filter has a first (uppermost) layer that includes diamond-like carbon (DLC) and has a second (lowermost) layer that includes CrSiCN.

### BRIEF DESCRIPTION OF THE DRAWINGS

FIG. 1 is a perspective view of an illustrative electronic device of the type that may be provided with conductive structures and visible-light-reflecting coatings in accordance with some embodiments.

FIG. 2 is cross-sectional side view of an illustrative electronic device having conductive structures that may be provided with visible-light-reflecting coatings in accordance with some embodiments.

FIG. 3 is an exploded cross-sectional side view of an illustrative conductive housing sidewall that may be provided with a visible-light-reflecting coating in accordance with some embodiments.

FIG. 4 is a cross-sectional side view of an illustrative visible-light-reflecting coating having a two-layer interference film and an underlying opaque coloring layer in accordance with some embodiments.

FIG. 5 is a cross-sectional side view of an illustrative visible-light-reflecting coating having a two-layer interference film with two CrSiCN layers on an underlying opaque coloring layer in accordance with some embodiments.

FIG. 6 is a cross-sectional side view of an illustrative visible-light-reflecting coating having a two-layer interference film with an uppermost diamond-like carbon (DLC) layer and a lowermost CrSiCN layer on an underlying opaque coloring layer in accordance with some embodiments.

### DETAILED DESCRIPTION

Electronic devices and other items may be provided with conductive structures. Coatings may be formed on the conductive structures to reflect particular wavelengths of visible light so that the conductive structures exhibit a desired color. A visible-light-reflecting coating may be deposited on a conductive substrate. The coating may include adhesion and transition layers on the substrate, an opaque coloring layer on the adhesion and transition layers, and a two-layer thin-film interference filter on the opaque coloring layer. The lowermost layer of the two-layer thin-film interference filter may include CrSiCN. The uppermost layer of the two-layer thin-film interference filter may include diamond-like carbon (DLC) or CrSiCN. The coating may exhibit a dark blue or black color that exhibits a relatively uniform visual response even when the underlying conductive structures have a three-dimensional shape.

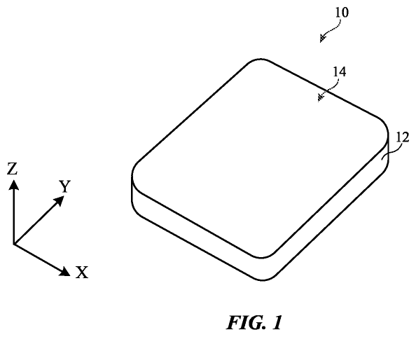

An illustrative electronic device of the type that may be provided with conductive structures and visible-light-reflecting coatings is shown in FIG. 1. Electronic device 10 of FIG. 1 may be a computing device such as a laptop computer, a computer monitor containing an embedded computer, a tablet computer, a cellular telephone, a media player, or other handheld or portable electronic device, a smaller device such as a wristwatch device (e.g., a watch with a wrist strap), a pendant device, a headphone or earpiece device, a device embedded in eyeglasses or other equipment worn on a user's head (e.g., a head mounted device such as a virtual or augmented reality headset), or other wearable or miniature device, a television, a computer display that does not contain an embedded computer, a gaming device, a navigation device, an embedded system such as a system in which electronic equipment with a display is mounted in a kiosk or automobile, a wireless base station, a home entertainment system, a wireless speaker device, a wireless access point, equipment that implements the functionality of two or more of these devices, or other electronic equipment. In the illustrative configuration of FIG. 1, device 10 is a portable device having a substantially rectangular lateral outline such as a cellular telephone or tablet computer. Other configurations may be used for device 10 if desired. The example of FIG. 1 is merely illustrative.

In the example of FIG. 1, device 10 includes a display such as display 14. Display 14 may be mounted in a housing such as housing 12. Housing 12, which may sometimes be referred to as an enclosure or case, may be formed of plastic, glass, ceramics, fiber composites, metal (e.g., stainless steel, aluminum, etc.), other suitable materials, or a combination of any two or more of these materials. Housing 12 may be formed using a unibody configuration in which some or all of housing 12 is machined or molded as a single structure or may be formed using multiple structures (e.g., an internal frame structure, one or more structures that form exterior housing surfaces, etc.). Housing 12 may have metal sidewalls or sidewalls formed from other materials. Examples of metal materials that may be used for forming housing 12 include stainless steel, aluminum, silver, gold, titanium, metal alloys, or any other desired conductive material.

Display 14 may be formed at (e.g., mounted on) the front side (face) of device 10. Housing 12 may have a rear housing wall on the rear side (face) of device 10 that opposes the front face of device 10. Conductive housing sidewalls in housing 12 may surround the periphery of device 10. The rear housing wall of housing 12 may be formed from conductive materials and/or dielectric materials.

The rear housing wall of housing 12 and/or display 14 may extend across some or all of the length (e.g., parallel to the X-axis of FIG. 1) and width (e.g., parallel to the Y-axis) of device 10. Conductive sidewalls of housing 12 may extend across some or all of the height of device 10 (e.g., parallel to Z-axis).

Display 14 may be a touch screen display that incorporates a layer of conductive capacitive touch sensor electrodes or other touch sensor components (e.g., resistive touch sensor components, acoustic touch sensor components, force-based touch sensor components, light-based touch sensor components, etc.) or may be a display that is not touch-sensitive. Capacitive touch screen electrodes may be formed from an array of indium tin oxide pads or other transparent conductive structures.

Display 14 may include an array of display pixels formed from liquid crystal display (LCD) components, an array of electrophoretic display pixels, an array of plasma display pixels, an array of organic light-emitting diode (OLED) display pixels, an array of electrowetting display pixels, or display pixels based on other display technologies.

Display 14 may be protected using a display cover layer. The display cover layer may be formed from a transparent material such as glass, plastic, sapphire or other crystalline dielectric materials, ceramic, or other clear materials. The display cover layer may extend across substantially all of the length and width of device 10, for example.

Device 10 may include one or more buttons. The buttons may be formed from a conductive button member that is located within (e.g., protruding through) openings in housing 12 or openings in display 14 (as examples). Buttons may be rotary buttons, sliding buttons, buttons that are actuated by pressing on a movable button member, etc.

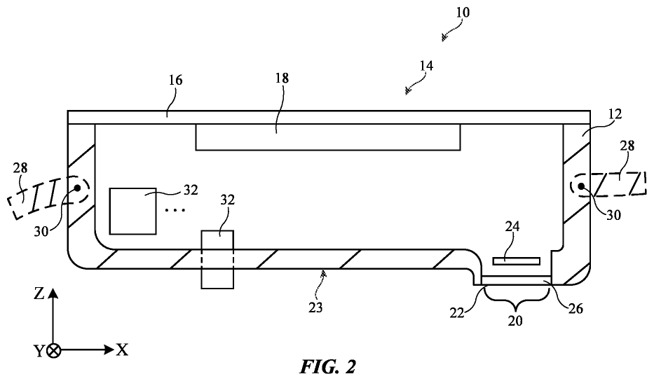

A cross-sectional side view of device 10 in an illustrative configuration in which display 14 has a display cover layer is shown in FIG. 2. As shown in FIG. 2, display 14 may have one or more display layers that form pixel array 18. During operation, pixel array 18 forms images for a user in an active area of display 14. Display 14 may also have inactive areas (e.g., areas along the border of pixel array 18) that are free of pixels and that do not produce images. Display cover layer 16 of FIG. 2 overlaps pixel array 18 in the active area and overlaps electrical components in device 10.

Display cover layer 16 may be formed from a transparent material such as glass, plastic, ceramic, or crystalline materials such as sapphire. Illustrative configurations in which a display cover layer and other transparent members in device 10 (e.g., windows for cameras and other light-based devices that are formed in openings in housing 12) are formed from a hard transparent crystalline material such as sapphire (sometimes referred to as corundum or crystalline aluminum oxide) may sometimes be described herein as an example. Sapphire makes a satisfactory material for display cover layers and windows due to its hardness (9 Mohs). In general, however, these transparent members may be formed from any suitable material.

Display cover layer 16 for display 14 may be planar or curved and may have a rectangular outline, a circular outline, or outlines of other shapes. If desired, openings may be formed in the display cover layer. For example, an opening may be formed in the display cover layer to accommodate a button, a speaker port, or other component. Openings may be formed in housing 12 to form communications or data ports (e.g., an audio jack port, a digital data port, a port for a subscriber identity module (SIM) card, etc.), to form openings for buttons, or to form audio ports (e.g., openings for speakers and/or microphones).

Device 10 may, if desired, be coupled to a strap such as strap 28 (e.g., in scenarios where device 10 is a wristwatch device). Strap 28 may be used to hold device 10 against a user's wrist (as an example). Strap 28 may sometimes be referred to herein as wrist strap 28. In the example of FIG. 2, wrist strap 28 is connected to attachment structures 30 in housing 12 at opposing sides of device 10. Attachment structures 30 may include lugs, pins, springs, clips, brackets, and/or other attachment mechanisms that configure housing 12 to receive wrist strap 28. Configurations that do not include straps may also be used for device 10.

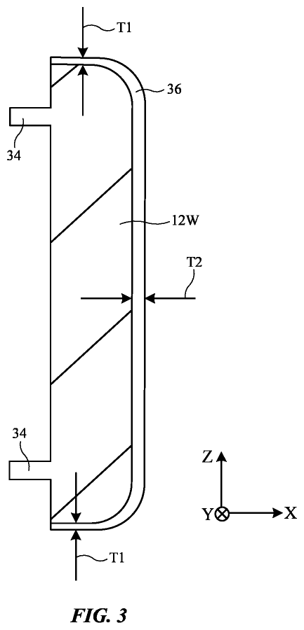

If desired, light-based components such as light-based components 24 may be mounted in alignment with an opening 20 in housing 12. Opening 20 may be circular, may be rectangular, may have an oval shape, may have a triangular shape, may have other shapes with straight and/or curved edges, or may have other suitable shapes (outlines when viewed from above). Window member 26 may be mounted in window opening 20 of housing 12 so that window member 26 overlaps component 18. A gasket, bezel, adhesive, screws, or other fastening mechanisms may be used in attaching window member 26 to housing 12. Surface 22 of window member 26 may lie flush with exterior surface 23 of housing 12, may be recessed below exterior surface 23, or may, as shown in FIG. 3, be proud of exterior surface 23 (e.g., surface 22 may lie in a plane that protrudes away from surface 23 in the −Z direction). In other words, window member 26 may be mounted to a protruding portion of housing 12. Surface 23 may, for example, form the rear face of housing 12.

Conductive structures in device 10 may be provided with a visible-light-reflecting coating that reflects certain wavelengths of light so that the conductive structures exhibit a desired aesthetic appearance (e.g., a desired color, reflectivity, etc.). The conductive structures in device 10 may include, for example, conductive portions of housing 12 (e.g., conductive sidewalls for device 10, a conductive rear wall for device 10, a protruding portion of housing 12 used to mount window member 26, etc.), attachment structures 30, conductive portions of wrist strap 28, a conductive mesh, conductive components 32, and/or any other desired conductive structures on device 10. Conductive components 32 may include internal components (e.g., internal housing members, a conductive frame, a conductive chassis, a conductive support plate, conductive brackets, conductive clips, conductive springs, input-output components or devices, etc.), components that lie both at the interior and exterior of device 10 (e.g., a conductive SIM card tray or SIM card port, a data port, a microphone port, a speaker port, a conductive button member for a ringer button, power button, volume button, or other buttons, etc.), components that are mounted at the exterior of device 10 (e.g., conductive portions of strap 28 such as a clasp for strap 28), and/or any other desired conductive structures on device 10.

FIG. 3 is an exploded cross-sectional side view of a conductive sidewall in device 10 that may be provided with a visible-light-reflecting coating. As shown in FIG. 3, housing 12 may include peripheral conductive housing structures such as conductive sidewall 12W. Conductive sidewall 12W may, for example, run around the lateral periphery of device 10 in the X-Y plane (e.g., conductive sidewall 12W may run around the periphery of display 14 of FIG. 2 and may serve as a conductive bezel for the display).

Conductive sidewall 12W may include one or more ledges 34. Ledges 34 may be used to support a conductive and/or dielectric rear wall for device 10 (e.g., at the rear face of device 10) and/or to support display cover layer 16 of FIG. 2 (e.g., at the front face of device 10). In order to provide conductive sidewall 12W with a desired visible color, a visible-light-reflecting coating such as coating 36 may be deposited onto conductive sidewall 12W (e.g., all of conductive sidewall 12W, the portions of conductive sidewall 12W at the exterior of device 10, etc.). Coating 36 may also be deposited over other conductive structures in device 10 (e.g., conductive components 32 of FIG. 2, other conductive portions of housing 12, etc.).

In practice, the coating may have different thicknesses across its surface area due to changes in the underlying geometry of the conductive structure (e.g., because of coating deposition equipment limitations in depositing uniform coatings across the underlying geometry). For example, coating 36 of FIG. 3 may exhibit a first thickness T1 at the bottom and top edges of conductive sidewall 12W (e.g., where conductive sidewall 12W exhibits a curved three-dimensional shape) but may exhibit a second thickness T2 along the center of conductive sidewall 12W (e.g., where conductive sidewall 12W exhibits a substantially planar shape). Thickness T2 may represent the maximum thickness of coating 36 across its surface area (e.g., 100% thickness). Thickness T1 may be less than thickness T2 (e.g., 30-70% of thickness T2). If care is not taken, variations in thickness along the surface area of coating 36 can undesirably alter the color of visible light reflected by the coating and thus the aesthetic appearance of the underlying conductive structure.

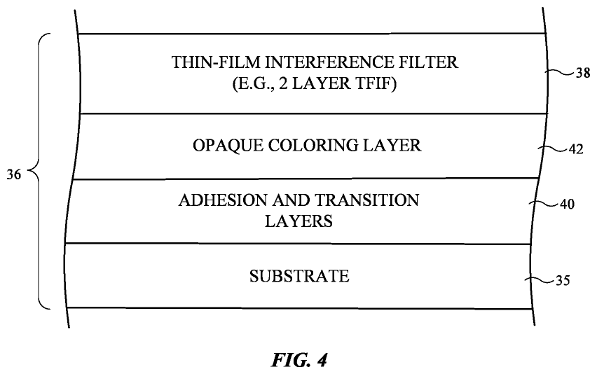

To configure a conductive structure in device 10 to exhibit a desired color across different conductive structure geometries, the conductive structure may be provided with a visible-light-reflecting coating having a two-layer thin-film interference filter. FIG. 4 is a cross-sectional diagram of a visible-light-reflecting coating having a two-layer thin-film interference filter that may be provided on conductive structures in device 10 (e.g., portions of housing 12 of FIGS. 1 and 2, conductive components 32 of FIG. 2, conductive sidewall 12W of FIG. 3, etc.).

As shown in FIG. 4, a visible-light-reflecting coating such as coating 36 may be disposed (e.g., deposited, layered, formed, etc.) on a conductive substrate such as substrate 35. Substrate 35 may be a conductive structure in device 10 such as a conductive portion of housing 12 (FIGS. 1 and 2), a conductive component 32 (FIG. 2), or conductive sidewall 12W (FIG. 3). Substrate 35 may be thicker than coating 36. The thickness of substrate 35 may be 0.1 mm to 5 mm, more than 0.3 mm, more than 0.5 mm, between 5 mm and 20 mm, less than 5 mm, less than 2 mm, less than 1.5 mm, or less than 1 mm (as examples). Substrate 35 may include stainless steel, aluminum, titanium, or other metals or alloys. In other suitable arrangements, substrate 35 may be an insulating substrate such as a ceramic substrate, a glass substrate, or substrates formed from other materials.

Coating 36 may include adhesion and transition layers 40 on substrate 35. Coating 36 may include an opaque color layer such as opaque coloring layer 42 on adhesion and transition layers 40. Coating 36 may include a multi-layer thin-film interference filter such as thin-film interference filter (TFIF) 38 on opaque coloring layer 42. An optional oleophobic coating or other films, coatings, or layers (e.g., layers that do not substantially contribute to the color response of the coating) may be layered over thin-film interference filter 38 if desired. Opaque coloring layer 42 may, for example, have a first lateral surface that directly contacts adhesion and transition layers 40 and may have a second lateral surface opposite the first lateral surface.

Thin-film interference filter 38 may, for example, have a third lateral surface that directly contacts the second lateral surface and may have a fourth lateral surface opposite the third lateral surface (e.g., the fourth lateral surface may form an uppermost or outermost layer of coating 36). In general, thin-film interference filter 38 may include one, two, or more than two layers (films) stacked on opaque coloring layer 42. An implementation in which thin-film interference filter 38 includes two layers (films) is described herein as an example.

The layers of coating 36 may be deposited on substrate 35 using any suitable deposition techniques. Examples of techniques that may be used for depositing the layers in coating 36 include physical vapor deposition (e.g., evaporation and/or sputtering), cathodic arc deposition, chemical vapor deposition, ion plating, laser ablation, etc. For example, coating 36 may be deposited on substrate 35 in a deposition system having deposition equipment (e.g., a cathode). Substrate 35 may be moved (e.g., rotated) within the deposition system while the deposition equipment (e.g., the cathode) deposits the layers of coating 36. If desired, substrate 35 may be moved/rotated dynamically with respect to speed and/or orientation relative to the deposition equipment (e.g., the cathode) during deposition. This may help provide coating 36 with as uniform a thickness as possible across its area, even in scenarios where substrate 35 has a three-dimensional shape (e.g., minimizing the difference between thicknesses T1 and T2 of FIG. 3).

Thin-film interference filter 38 may be formed from a stack of two layers of material such as inorganic dielectric layers with different index of refraction values. The thin-film interference filter layers may have higher index of refraction values (sometimes referred to as “high” index values) and lower index of refraction values (sometimes referred to as “low” index values). The high index layers may be interleaved with the low index layers if desired. Incident light may be transmitted through each of the layers in thin-film interference filter 38 while also reflecting off the interfaces between each of the layers, as well as at the interface between the thin-film interference filter and opaque coloring layer 42 and at the interface between the thin-film interference filter and air. By controlling the thickness and index of refraction (e.g., composition) of each layer in thin-film interference filter 38, the light reflected at each interface may destructively and/or constructively interfere at a selected set of wavelengths such that reflected light that passes out of the thin-film interference filter 38 is perceived by an observer with a desired color and brightness across a corresponding range of viewing angles (angles of incidence, e.g., from 0 to 60 degrees relative to a normal axis of the conductive structure), while also exhibiting a response that is relatively invariant across the lateral area of the coating even when deposited onto an underlying substrate 35 having a three-dimensional (e.g., curved) shape.

Unlike the layers of thin-film interference filter 38, opaque color layer 42 is substantially opaque and does not transmit light incident upon coating 36. On the other hand, opaque color layer 42 may reflect incident light received through thin-film interference filter 38 back towards and through thin-film interference filter 38. The thickness and/or composition of opaque coloring layer 42 may contribute to the color response of the light upon exiting coating 36 as viewed by a user (e.g., in combination with the interference effects imparted to the transmitted and reflected light by thin-film interference filter 38). Opaque color layer 42 may sometimes also be referred to herein as a non-interference filter layer or an intrinsic color layer.

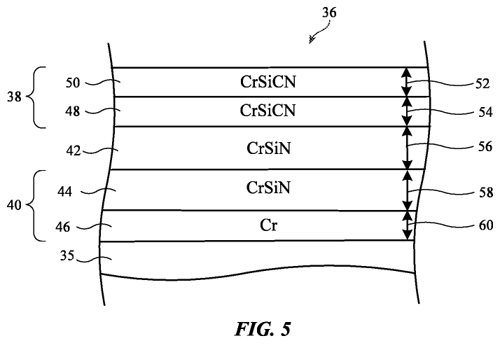

FIG. 5 is a cross-sectional side view showing one illustrative composition for coating 36. As shown in FIG. 5, adhesion and transition layers 40 may include a seed (adhesion) layer 46 on substrate 35 and one or more transition layers such as transition layer 44 on seed layer 46. Seed layer 46 may couple substrate 35 to transition layer 44 (e.g., transition layer 44 may be interposed between seed layer 46 and opaque coloring layer 42).

In the example of FIG. 5, seed layer 46 is formed from chromium (Cr) and may therefore sometimes be referred to herein as Cr layer 46 or Cr seed layer 46. Transition layer 44 may be formed from chromium silicon nitride (CrSiN) and may therefore sometimes be referred to herein as CrSiN layer 44. This is illustrative and non-limiting. In general, seed layer 46 and/or transition layer 44 may include chromium nitride (CrN), chromium silicon (CrSi), titanium (Ti), chromium carbide (CrC), chromium silicon nitride (CrSiN), chromium silicon carbonitride (CrSiCN), chromium silicon carbide (CrSiC), chromium carbonitride (CrCN), chromium (Cr), combinations of these, other metals, metal alloys, and/or other materials.

Seed layer 46 may have a thickness 60. Thickness 60 may be, for example, 0.1-1.0 microns, 0.1-0.5 microns, 0.05-0.75 microns, 0.2-0.3 microns, 0.1-10 microns, 0.1-0.5 microns, 0.2-0.5 microns, 0.3-0.4 microns, or other thicknesses. Transition layer 44 may have a thickness 58. Thickness 58 may be, for example, 0.1-1.0 microns, 0.1-0.5 microns, 0.05-0.75 microns, 0.3-0.4 microns, 0.25-0.45 microns, 0.05-0.7 microns, 0.1-5 microns, 0.2-0.9 microns, or other thicknesses (e.g., greater than thickness 60).

In the example of FIG. 5, thin-film interference filter 38 is a two-layer interference filter having a first layer 48 and a second layer 50 on first layer 48. First layer 48 may be a lowermost (bottom) layer of thin-film interference filter 38 that is layered onto opaque color layer 42. Second layer 50 may be an uppermost (top) layer of thin-film interference filter 38 that is layered onto first layer 48.

Layer 50 may include chromium, silicon, carbon, and nitrogen (e.g., chromium silicon carbonitride (CrSiCN)) and may sometimes also be referred to herein as CrSiCN layer 50 (or equivalently as SiCrCN layer 50). Layer 48 may also include chromium, silicon, carbon, and nitrogen (e.g., CrSiCN) and may sometimes also be referred to herein as CrSiCN layer 48 (or equivalently as SiCrCN layer 48). The relative amount of each element per unit volume of layer 50 may be different than that of layer 48. This may configure layers 50 and 48 to exhibit different refractive indices, allowing for optical reflection at the interface between layers 50 and 48 to contribute to the overall color response of thin-film interference filter 38 and thus coating 36. In another implementation, layer 50 may include silicon, carbon, and nitrogen (e.g., silicon carbonitride (SiCN) (e.g., layer 50 may be an SiCN layer).

Layer 48 may have thickness 54. Layer 50 may have thickness 52. Thicknesses 52 and 54 and the compositions of layers 48 and 50 may be selected to impart thin-film interference filter 38 with desired interference effects to transmitted and reflected light, thereby configuring coating 36 to reflect visible light with a desired visible color response. Thickness 52 may be, for example, 60-70 nm, 70-80 nm, 50-80 nm, 40-90 nm, 20-100 nm, greater than 60 nm, greater than 50 nm, greater than 40 nm, less than 70 nm, less than 80 nm, less than 100 nm, or other thicknesses (e.g., greater than thickness 60). Thickness 54 may be, for example, 30-40 nm, 40-50 nm, 50-70 nm, 20-80 nm, 10-100 nm, 25-65 nm, greater than 30 nm, greater than 20 nm, less than 60 nm, less than 70 nm, less than 80 nm, less than 40 nm, less than 50 nm, less than 100 nm, or other thicknesses (e.g., less than thickness 52).

The composition of layer 50 may be selected such that the atomic percentage of Cr atoms in layer 50 is 25-30%, 20-35%, 15-40%, greater than 25%, greater than 20%, greater than 15%, less than 30%, less than 40%, or other values. The composition of layer 50 may be selected such that the atomic percentage of Si atoms in layer 50 is 40-45%, 37-46%, 25-50%, 35-52%, greater than 40%, greater than 30%, greater than 25%, less than 50%, less than 60%, or other values. The composition of layer 50 may be selected such that the atomic percentage of N atoms in layer 50 is 25-30%, 20-35%, 15-40%, greater than 25%, greater than 20%, greater than 15%, less than 30%, less than 40%, or other values.

The composition of layer 48 may be selected such that the atomic percentage of Cr atoms in layer 48 is 30-35%, 25-40%, 20-47%, greater than 30%, greater than 25%, greater than 15%, less than 38%, less than 44%, or other values (e.g., greater than the atomic % of Cr atoms in layer 50). The composition of layer 48 may be selected such that the atomic percentage of Si atoms in layer 48 is 35-40%, 31-47%, 25-50%, 35-52%, greater than 30%, greater than 20%, greater than 25%, less than 40%, less than 50%, or other values (e.g., less than the atomic % of Si atoms in layer 50). The composition of layer 48 may be selected such that the atomic percentage of N atoms in layer 48 is 25-30%, 20-35%, 15-40%, greater than 25%, greater than 20%, greater than 15%, less than 30%, less than 40%, or other values.

The thickness and/or composition of opaque color layer 42 also contributes to the color response of coating 36. Opaque color layer 42 having thickness 56. Opaque color layer 42 may include CrSiN, as one example, and may therefore sometimes also be referred to herein as CrSiN layer 42. This is merely illustrative and, in general, opaque color layer 42 may include other materials. Coating 36 may include a single opaque color layer 42 (as shown in FIG. 5), two or more opaque color layers 42 stacked on top of each other between thin-film interference filter 38 and adhesion and transition layers 40, or may be omitted. Thickness 56 may be, for example, 300-500 nm, 400-500 nm, 500-600 nm, 200-700 nm, 100-800 nm, greater than 300 nm, greater than 200 nm, greater than 100 nm, less than 600 nm, less than 800 nm, or other thicknesses (e.g., greater than the thickness of thin-film interference filter 38).

The composition of opaque color layer 42 may be selected such that the atomic percentage of Cr atoms in layer 42 is 30-35%, 25-40%, 20-47%, greater than 30%, greater than 25%, greater than 15%, less than 38%, less than 44%, or other values (e.g., greater than the atomic % of Cr atoms in layer 50). The composition of layer 42 may be selected such that the atomic percentage of Si atoms in layer 42 is 30-35%, 25-40%, 20-47%, greater than 30%, greater than 25%, greater than 15%, less than 38%, less than 44%, or other values.

When configured this way, coating 36 may configure substrate 35 to exhibit a deep blue color that is relatively uniform even as the thickness of coating 36 changes due to the geometry of the underlying substrate 35. For example, at a location along the lateral area of coating 36 at which coating 36 exhibits peak/maximum thickness, when viewed at an angle of zero degrees relative to a normal axis/surface of the lateral area of coating 36, coating 36 of FIG. 5 may exhibit an L* value (in an L*a*b* color space) of greater than 35, greater than 38, greater than 30, greater than 25, 35-45, 30-50, 35-50, less than 40, less than 45, less than 50, or other L* values, an a* value (in the L*a*b* color space) of −5-5, −2-5, −1-1, −3-8, −10-10, −1-0, greater than −1, greater than −2, greater than −5, less than 0, less than 1, less than 2, less than 5, or other a* values, and a b* value (in the L*a*b* color space) of −5-20, −3-16, −10-25, less −5, less than 0, greater than −20, greater than −16, greater than −25, greater than −30, or other b* values.

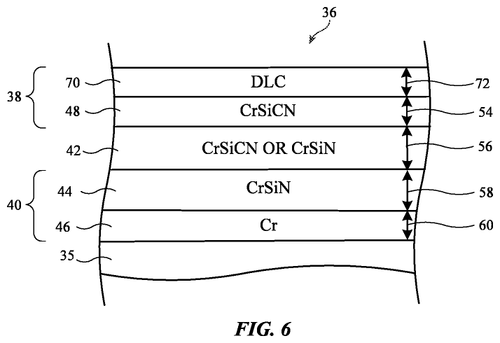

If desired, layer 50 of thin-film interference filter 38 may be replaced with a layer that includes diamond-like carbon, as shown in the example of FIG. 6. As shown in FIG. 6, thin-film interference filter 38 may include layer 70 that includes DLC, sometimes referred to herein as DLC layer 70 (e.g., an uppermost layer of thin-film interference filter 38 and coating 36). DLC layer 70 may be layered onto layer 48.

DLC is an amorphous, synthetic, carbon material having a relatively high number of sp³ hybridized carbon atoms (e.g., a ratio of sp³ hybridized carbon atoms relative to other atoms in the layer such as hydrogen atoms and/or sp² hybridized (graphite-like) carbon atoms that exceeds a threshold level), which imparts the material with diamond-like properties (e.g., diamond-like hardness, slickness, etc.). The DLC may also include one or more fillers (e.g., non-sp³ hybridized atoms) such as sp² hybridized carbon (e.g., graphite-like carbon) and/or hydrogen. If desired, the DLC may be provided with nitrogen (N) atoms (e.g., to help increase corrosion resistance) and/or one or more metal dopants (e.g., to help increase conductivity).

In the implementation of FIG. 6, opaque layer 42 may include CrSiN (e.g., may be a CrSiN layer) or may include CrSiCN (e.g., may be a CrSiCN layer), as examples. DLC layer 70 may have thickness 72. In general, thickness 72 may be 10-100 nm, thickness 54 may be 40-700 nm, and thickness 56 may be 500-700 nm, 400-800 nm, 200-900 nm, greater than 500 nm, greater than 400 nm, greater than 300 nm, less than 700 nm, less than 800 nm, or other thicknesses (e.g., less than thickness 54).

As a more specific example, in a first implementation, thickness 72 is 55-65 nm, 50-70 nm, 40-80 nm, 32-91 nm, greater than 55 nm, greater than 50 nm, greater than 40 nm, less than 70 nm, less than 80 nm, less than 100 nm, or other thicknesses. In the first implementation, thickness 54 is substantially greater than thickness 72. For example, thickness 54 may be 400-500 nm, 300-600 nm, 410-465 nm, greater than 400 nm, greater than 200 nm, greater than 100 nm, less than 500 nm, less than 600 nm, less than 700 nm, or other thicknesses greater than thickness 72.

In a second implementation, thickness 72 is 25-30 nm, 20-40 nm, 10-50 nm, greater than 25 nm, greater than 20 nm, greater than 15 nm, less than 35 nm, less than 40 nm, less than 50 nm, or other thicknesses. In the second implementation, thickness 54 is substantially greater than thickness 72. For example, thickness 54 may be 300-400 nm, 200-500 nm, greater than 300 nm, greater than 100 nm, less than 400 nm, less than 600 nm, or other thicknesses greater than thickness 72.

In a third implementation, thickness 72 is 30-35 nm, 25-40 nm, 20-50 nm, greater than 25 nm, greater than 30 nm, greater than 15 nm, less than 35 nm, less than 40 nm, less than 50 nm, or other thicknesses. In the third implementation, thickness 54 is similar to thickness 72. For example, thickness 54 may be 40-45 nm, 35-48 nm, 30-50 nm, 20-60 nm, greater than 40 nm, greater than 35 nm, greater than 30 nm, less than 45 nm, less than 50 nm, less than 60 nm, or other thicknesses.

In a fourth implementation, thickness 72 is 25-30 nm, 20-40 nm, 10-50 nm, greater than 25 nm, greater than 20 nm, greater than 15 nm, less than 35 nm, less than 40 nm, less than 50 nm, or other thicknesses. In the fourth implementation, thickness 54 is 100-120 nm, 80-140 nm, 70-150 nm, greater than 100 nm, greater than 90 nm, less than 120 nm, less than 150 nm, or other thicknesses (e.g., greater than thickness 72).

In a fifth implementation, thickness 72 is 15-25 nm, 10-30 nm, 10-40 nm, greater than 15 nm, greater than 10 nm, greater than 5 nm, less than 25 nm, less than 30 nm, less than 50 nm, or other thicknesses. In the fifth implementation, thickness 54 is 150-200 nm, 170-196 nm, 140-220 nm, greater than 150 nm, greater than 100 nm, less than 200 nm, less than 250 nm, or other thicknesses (e.g., greater than thickness 72).

In a sixth implementation, thickness 72 is 25-30 nm, 20-40 nm, 10-50 nm, greater than 25 nm, greater than 20 nm, greater than 15 nm, less than 35 nm, less than 40 nm, less than 50 nm, or other thicknesses. In the sixth implementation, thickness 54 is 300-400 nm, 200-500 nm, greater than 300 nm, greater than 100 nm, less than 400 nm, less than 600 nm, or other thicknesses greater than thickness 72 (e.g., greater than thickness 72).

In a seventh implementation, thickness 72 is 70-75 nm, 50-90 nm, 60-80 nm, greater than 70 nm, greater than 60 nm, greater than 50 nm, less than 75 nm, less than 80 nm, less than 100 nm, or other thicknesses. In the seventh implementation, thickness 54 is 50-70 nm, 55-65 nm, greater than 50 nm, greater than 40 nm, less than 75 nm, less than 80 nm, or other thicknesses.

In an eighth implementation, thickness 72 is 75-80 nm, 70-85 nm, 60-90 nm, greater than 75 nm, greater than 70 nm, greater than 50 nm, less than 85 nm, less than 90 nm, less than 100 nm, or other thicknesses. In the seventh implementation, thickness 54 is 40-50 nm, 30-60 nm, greater than 40 nm, greater than 30 nm, less than 50 nm, less than 60 nm, or other thicknesses.

When configured in this way (e.g., in any of the first through eighth implementations or other implementations), coating 36 may configure substrate 35 to exhibit an attractive deep black color with a blue-hued tint as the coating and substrate are viewed across different angles (e.g., as opposed to a yellow-hued tint in implementations where the TFIF is replaced with a single opaque color layer such as an opaque DLC layer). The color response of coating 36 and substrate 35 is relatively uniform even as the thickness of coating 36 changes due to the geometry of the underlying substrate 35. For example, at a location along the lateral area of coating 36 at which coating 36 exhibits peak/maximum thickness, when viewed at an angle of zero degrees relative to a normal axis/surface of the lateral area of coating 36, coating 36 of FIG. 6 may exhibit an L* value (in an L*a*b* color space) of greater than 44, greater than 42, greater than 40, greater than 38, 35-45, 30-50, 35-50, less than 50, less than 55, less than 60, or other L* values, an a* value (in the L*a*b* color space) of −5-5, −2-5, −1-1, −3-8, −10-10, −1-0, greater than −1, greater than −2, greater than −5, less than 0, less than 1, less than 2, less than 5, or other a* values, and a b* value (in the L*a*b* color space) of between −1 and −3, between −1 and −15, less than 0, less than −1, greater than −20, greater than −25, or other b* values.

The examples of FIGS. 5 and 6 are merely illustrative. Additional elements may be included in one or more of the layers of coating 36. The layers may be arranged in other orders. The layers may have different thicknesses or compositions. The coating may have other color profiles and angular responses. The layers described herein may sometimes also be referred to as films.

Device 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is merely illustrative and various modifications can be made to the described embodiments. The foregoing embodiments may be implemented individually or in any combination.

What is claimed is:

1. Apparatus comprising:
a conductive substrate; and
a coating on the conductive substrate and having a color, the coating comprising:
adhesion and transition layers, and
a two-layer thin-film interference filter on the adhesion and transition layers, wherein the two-layer thin-film interference filter comprises a CrSiCN layer.

2. The apparatus of claim 1, wherein the CrSiCN layer is a lowermost layer of the two-layer thin-film interference filter.

3. The apparatus of claim 2, wherein the two-layer thin-film interference filter further comprises an additional CrSiCN layer on the CrSiCN layer.

4. The apparatus of claim 3, wherein the coating further comprises an opaque CrSiN layer between the adhesion and transition layers and the CrSiCN layer.

5. The apparatus of claim 4, wherein the adhesion and transition layers comprise a Cr seed layer on the substrate and a CrSiN transition layer between the Cr seed layer and the opaque CrSiN layer.

6. The apparatus of claim 3, wherein the additional CrSiCN layer is thicker than the CrSiCN layer.

7. The apparatus of claim 6, wherein the additional CrSiCN layer is more than 60 nm thick and the CrSiCN layer is less than 50 nm thick.

8. The apparatus of claim 3, wherein an atomic percentage of Cr atoms in the additional CrSiCN layer is less than 30%, an atomic percentage of Si atoms in the additional CrSiCN layer is greater than 30%, and an atomic percentage of C atoms in the additional CrSiCN layer is less than 30%.

9. The apparatus of claim 8, wherein an atomic percentage of Cr atoms in the CrSiCN layer is greater than 25%, an atomic percentage of Si atoms in the CrSiCN layer is less than 40%, and an atomic percentage of C atoms in the additional CrSiCN layer is greater than 20%.

10. The apparatus of claim 2, wherein the two-layer thin-film interference filter further comprises a diamond-like carbon (DLC) layer on the CrSiCN layer.

11. The apparatus of claim 10, wherein the CrSiCN layer is thicker than the DLC layer.

12. The apparatus of claim 11, wherein the CrSiCN layer is more than 200 nm thick and the DLC layer is less than 100 nm thick.

13. The apparatus of claim 10, further comprising an opaque layer between the adhesion and transition layers and the CrSiCN layer, the opaque layer comprising carbon, silicon, and nitrogen.

14. The apparatus of claim 1 wherein, at a location of maximum thickness and a viewing angle of zero degrees relative to a normal axis of the coating, the coating has an L* value greater than 30, an a* value between −10 and 10, and a b* value between −20 and 0.

15. An electronic device comprising:
a conductive structure; and
a coating on the conductive structure and having a color, the coating comprising:
adhesion and transition layers, and
a thin-film interference filter on the adhesion and transition layers, wherein the thin-film interference filter has an uppermost layer that includes CrSiCN and has a lowermost layer that includes CrSiCN.

16. The electronic device of claim 15, wherein the uppermost layer directly contacts the lowermost layer of the thin-film interference filter.

17. The electronic device of claim 15, the coating further comprising:
an opaque layer between the thin-film interference filter and the adhesion and transition layers, the opaque layer comprising CrSiN.

18. An electronic device comprising:
a conductive structure; and
a coating on the conductive structure and having a color, the coating comprising:
adhesion and transition layers, and
a thin-film interference filter on the adhesion and transition layers, wherein the thin-film interference filter has a first layer that includes diamond-like carbon (DLC) and has a second layer that includes CrSiCN.

19. The electronic device of claim 18, wherein the second layer is interposed between the first layer and the adhesion and transition layers.

20. The electronic device of claim 18, the coating further comprising:
an opaque layer between the thin-film interference filter and the adhesion and transition layers, the opaque layer comprising CrSiCN.
